(19) United States
(12) Patent Application Publication
(10) Pub. No.: US 2007/0063020 A1
(43) Pub. Date: Mar. 22, 2007

(54) System and method for charity gift card

(75) Inventor: Eleanor D. Barrafato, Richmond, VA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: CAPITAL ONE FINANCIAL CORPORATION

(21) Appl. No.: 11/232,342

(22) Filed: Sep. 21, 2005

(51) Int. Cl. G06K 5/00; G07F 19/00

(52) U.S. Cl. 235/380; 235/379

(57) ABSTRACT

Systems and methods enable the provision, management and use of a monetary card for making donations. A processor may cause information associated with donation parameters to be stored on a monetary card. The card may be given as a gift to a recipient. The recipient may use the card to make a donation to a donation recipient. The donation may be made by way of any suitable method or configuration. In one example scenario, the donation is made by the card recipient using a web-based communication system to specify one or more values associated with the donation parameters. For example, the card recipient may use the card to access an account or record and may select a donation recipient from among a list of available donation recipients and may also specify an amount to be donated. The donation may be linked to a separate financial account which may be held, for instance, by the purchaser of the card. The separate financial account may be debited when the card is first purchased, or when a donation is actually made by the card recipient.

### BACKGROUND

Gift cards are a common product in the financial and merchandising industries. Typically, a gift card can be purchased by a consumer and given as a gift to a recipient. Gift cards are typically pre-loaded with one of a variety of different dollar amounts. The customer selects the dollar value of the card and purchases the card having the selected dollar amount from a store providing the cards. For example, a music store may display cards in $10, $50, and $100 increments. A customer chooses from among the pre-loaded cards, the card having the particular dollar amount which the customer wants to provide as a gift to the recipient. The customer purchases the card and the store activates the card. Then, the customer may give the card to the intended recipient. Typically, the card has a magnetic stripe that includes the dollar value of the card and data associating the card with the store where the card may be used. The recipient uses the card to make purchases (up to the pre-selected dollar amount) at the store which sold the card.

### SUMMARY OF THE INVENTION

Various embodiments of the present invention are generally directed to systems and methods for providing and managing a charity gift card. According to certain aspects the gift card enables the recipient to make a charitable donation, rather than making a merchandise purchase from a store.

In one embodiment a system is provided for enabling donations. The system include at least one processor and at least one data storage device electronically coupled to the at least one processor. The at least one processor is operable to receive, from a first entity, a purchase request comprising a selection of one or more donation parameters, the selection comprising at least one potential donation recipient and at least a monetary amount. The at least one data storage device is operable to store information associated with the purchase request. The at least one processor is further operable to receive a donation request comprising at least one donation recipient and at least one monetary amount.

Another embodiment includes a method for providing a donation gift card. One step includes providing a card to a first entity. The card incorporates at least a first value corresponding to a first donation parameter. Another step includes receiving information associated with a donation after the donation has been made using the card. The donation information corresponds to the first donation parameter.

Various embodiments of the present invention may benefit from numerous advantages. It should be noted that one or more embodiments may benefit from some, none, or all of the advantages discussed below.

One advantage of the invention is that a monetary card may be used as the medium for making a charitable donation. This facilitates the ease in which charitable donations may be made. The monetary card may include pre-loaded dollar amounts and may allow flexibility in selecting the charity or charities which will receive money.

Another advantage of the certain embodiments is the provision of a unique type of gift which may be given to a recipient in connection with any of a variety of occasions. Often times, gift recipients would rather have a donation made to a charity than receive an actual gift. Various embodiments of the charity gift card allow the

gift giver to enable the recipient to make the donation themselves instead of having the donation made in their name or on their behalf. The recipient can also be provided with the flexibility to make the donation to one or more charities as the recipient sees fit.

Another advantage of certain embodiments is that a recipient of the charity gift card may make a charitable donation without certain specific details of the donation (such as the identity of the charity) being known to others, including the gift giver.

Another advantage of certain embodiments is that a gift giver may enable a recipient to make a charitable donation according to a process which is relatively easy on both the giver and the recipient. In prior scenarios, a giver that wanted to make a charitable donation on behalf of a recipient actually had to taker certain affirmative steps to conduct the charitable donation transaction with the respective charity. In certain cases, the giver might actually have to select the charity, determine how to make a donation to the charity, and then execute the transaction directly with the charity.

A further advantage is that the charity gift card better allows for the recipient of the gift card (rather than the gift giver) to receive credit for the charitable donation. Such “credit” may include social recognition and/or actual financial credit, such as a taxable deduction. Of course, in certain configurations, the giver of the gift card may retain the credit or tax deduction, or the giver may be able to designate who can take advantage of the deduction. In still other scenarios, the credit or tax deduction may be set as a default.

Other advantages will be readily apparent to one having ordinary skill in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 illustrates an example system for providing, activating, and using a monetary card to enable a recipient to make donations in accordance with an embodiment of the invention; and

FIG. 2 illustrates an example method for providing, activating, and using a monetary card to make donations in accordance with an embodiment of the invention.

### DETAILED DESCRIPTION

Generally, various embodiments of the present invention are directed to using a monetary card, such as a gift card, to enable a recipient of the card to make charitable donations. Although the term “charitable” is used, the donations are not necessarily limited to any particular type of donations and no particular associated tax consequences. Any donation may be made using the various embodiments discussed herein. Further, while the term “charity” is referred to as an example of a donation recipient, the recipient of the donation may be any entity capable of receiving a donation and the term “charity” is not intended to be limited to any particular type of recipient and is not in reference to any particular legal or governmental requirements for qualifying as a “charity.” In certain embodiments, systems are described by which the cards are provided, donations are made and accounts settled. In other embodiments, methods are discussed according to which a card may be used as a gift and the recipient may use the card to make a charitable donation. Among other things, certain aspects are directed to how information regarding dollar amounts, charity identifications, personal identification numbers ({PINs), and other information may be incorporated into a monetary card. Other aspects related to the ways in which the card may be set up to enable the purchaser (i.e., the giver) and recipient to have a certain degree of flexibility in selecting the type of card and redeeming the card in order to make donations to selected charities. An example system will be described first. This will be followed by a discussion of an example method of providing and using the charity gift card.

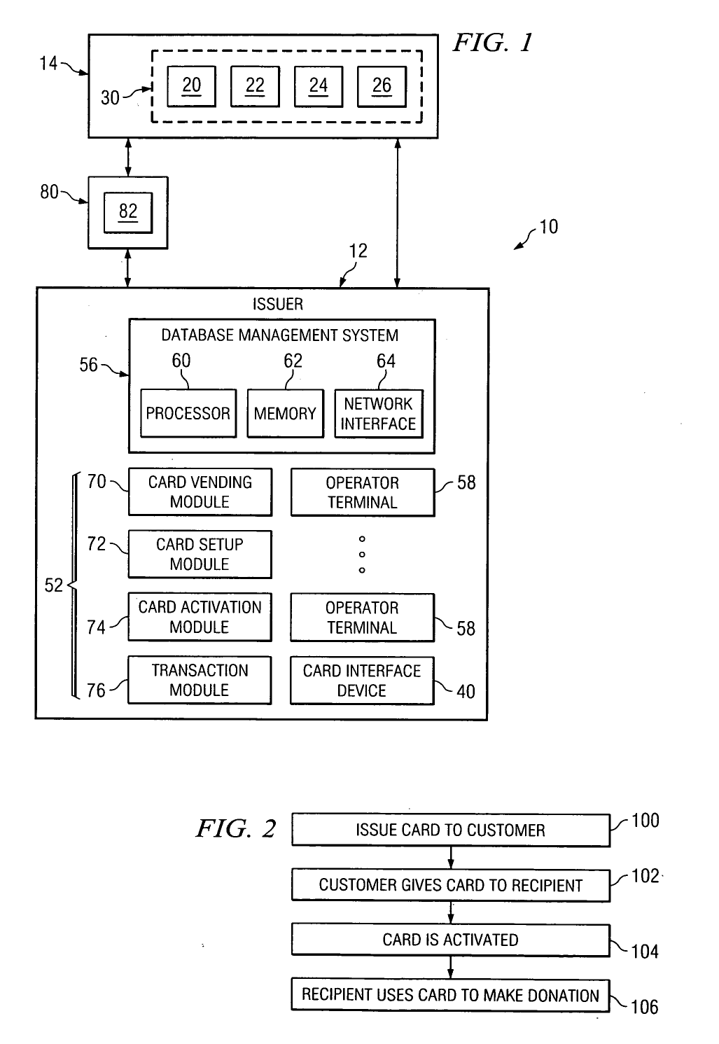

Thus, example embodiments of the present invention and their advantages are best understood by referring now to FIGS. 1 and 2 of the drawings, in which like numerals refer to like parts. FIG. 1 illustrates an example system 10 for providing, activating, and using a gift card to enable a recipient of the gift card to make charitable donations in accordance with an example embodiment of the invention. System 10 may include an issuer 12 and a plurality of gift cards 14 provided by issuer 12. Generally, an issuer 12 sells or otherwise provides cards 14 to customers that may be used to make the charitable donations.

A card 14, although referred to in certain cases as a “gift card,” may be any suitable type of card enabling the recipient to make a charitable donation. Thus, the card may be called a gift card, stored-value card, monetary card, credit card, or debit card, or by any other name. Also, although the example system will be discussed in terms of a card having certain specific information incorporated into the card (e.g., on a magnetic stripe on the card), other types of card and non-card scenarios are envisioned. For example, a credit-card may allow the recipient to make charitable donations in a similar manner to the gift card. Moreover, a non-card type of account may be established for the gift recipient to make charitable donations in a similar manner.

Card 14 may be any card having one or more memory devices 30 provided on the card 14 that can store various data, such as a monetary value 20, a personal identification code 22, a card identification code 24 and/or an expiration date 26, as discussed below. For example, a card 14 may be a stored value cards or a smart card, such as a gift certificate card, that includes memory for storing various data related to the card 14.

An issuer 12 may sell cards 14 that may be used to make charitable donations. Issuer 12 may be a store, an online company, a financial institution, a credit card issuing company, or any other entity that makes the charity gift cards available for purchase by a customer. In this example, issuer 14 is a financial institution that also provides financial accounts, such as credit card accounts.

Cards 14 may be stored value cards or smart cards, such as gift certificate cards or store cards, for example, that include memory for storing the current monetary value of each card 14. Card 14 may have a particular monetary value 20 which may be stored in a memory device 30 provided on the card 14. As used herein, the phrase “provided on card 14” with reference to memory devices 30 or other devices (e.g., a processor) describes any physical coupling of such devices to a card 14, such as the device being provided on a surface of the card 14, located at least partially within the card 14, or otherwise physically coupled to the card 14.

The monetary value 20 may be pre-loaded onto a card 14, or a card 14 may be loaded with a monetary value 20 selected and paid for by a customer. For example, issuer 12 may sell charity cards 14 which are pre-loaded with various monetary values, such as $20, $50, and $100. Alternatively, issuer 12 may sell an unloaded charity gift card 14, which may be loaded with any amount desired by the customer purchasing the card 14. In one embodiment, issuer 12 provides the cards 14 through a web site. Customers select the type of card 14 desired and the amount desired to be loaded on the card 14. Then, the customer makes an online payment and the card 14 is mailed to the customer or a recipient designated by the customer. The “type of card” can refer to any of a variety of donation configurations. For example, the card may be set up such that the customer selects a single charity for which the receiver of the card can make donations. The selection may be from a predetermined list provided by the issuer 12, of the customer may specify a particular charity or charities, which the issuer may approve or reject. Optionally, the customer may choose a plurality of charities. In this case, the customer may determine that the receiver will be able to make specified donations to each of the plurality of charities. For example, the customer might select Charities A and C from the list of the charities offered by issuer 12 and may further specify that certain amounts must be donated by the recipient to each of Charities A and C. Or, the customer may specify that other parameters associated with the donations, such as the recipient being required to donate an amount within a certain range to Charity A and another amount within a certain range (or the remainder of the total initial amount) to Charity C. As another example alternative, the customer may also specify that the recipient will be able to make a second selection, from among the charities identified in the first selection by the customer, according to which contributions will be made. For instance, the customer might make a first selection of Charities A, B, C and D from the list of the charities offered by issuer 12. The recipient however, might choose to make a donation only to Charity A, or to Charities A and C.

The customer may also specify an amount for which the charitable donation will be made. Other parameters may be selected by the customer including, without limitation, a time parameter and a charity identity parameter. The various parameters will be discussed in greater detail below. The customer may also make a first selection among various parameters while enabling the recipient to also make a selection from among certain parameters.

The personal identification code 22 stored on a card 14 may provide security to prevent the card 14 from being used by unauthorized persons. For example, in some embodiments, in order to make donations using the card 14, a recipient (e.g. the card holder) must provide a code matching the personal identification code 22 stored on the card, such as by verbally communicating the code to a cashier or other personnel associated with the relevant issuer 12 or by entering the code into an interface, such as a card interface device 40, for example. In some embodiments, the personal identification code 22 is similar to a PIN or other security code, and may be selected by the customer (or purchaser) of the card 14, or by the recipient of the card 14. In certain embodiments, both the customer and the recipient will have personal identification code 22 associated with the card. For example, a configuration is envisioned in which a recipient must enter the code 22 in order to make a donation, but that the customer (i.e., the person that bought and gave the card) has to enter a code 22 to approve the donation. In certain cases, the issuer may need to establish a personal identification code 22. Each personal identification code 22 may include any number, combination and/or configuration of numbers, letters, symbols, characters, or any other data that may allow the personal identification code 22 to be identified and/or distinguished from other personal identification codes 22. The personal identification code 22 may be stored in a memory device 30 provided on the card 14, which may or may not be the same memory device 30 that stores the monetary value 20, card identification code 24 and/or expiration data 26 of the card 14.

The card identification code 24 stored on card 14 may be used to identify the card 14 from other cards 14. In some embodiments, each card 14 has a unique identification code 24. Card identification code 24 may be stored in a memory device 30 on card 14, which may or may not be the same memory device or devices 30 that store the monetary value 20, personal identification code 22 and/or expiration date 26 on the card 14.

The expiration date 26 stored on a card 14 may indicate a date and/or time that the card 14 may expire, may also be stored in a memory device 30 on card 14, which may or may not be the same memory device or devices 30 that store the monetary value 20, personal identification code 22 and/or card identification code 24 on the card 14.

The monetary value 20, personal identification code 22, and/or expiration date 24 may be stored in the same memory device 30, in separate memory devices 30 of the same type, or in separate memory devices 30 of different types. Memory device or devices 30 on a card may include any device or devices suitable to store data, such as one or more magnetic stripes, transistors, RFID devices, and/or memory chips, such as random access memories (RAMs), read-only memories (ROMs), dynamic random access memories (DRAMs), fast cycle RAMs (FCRAMs), static RAM (SRAMs), field-programmable gate arrays (FPGAs), erasable programmable read-only memories (EPROMs), electrically erasable programmable read-only memories (EEPROMs), or flash memory, for example. Other electronic devices may also be stored on cards 14, such as a processor operable to process various data stored in memory device(s) 30, for example.

In certain embodiments, to make a donation, the recipient card holder may engage a web site interface 82 of a web site 80. The web site 80 may be provided by the issuer 12, or the web site 80 may be separate from issuer 12. In at least one embodiment, web site 80 is linked, via any suitable communications network (such as the Internet) to issuer 12. This connection may be made through network interface 64. Web site interface 82 is preferably operable to provide a graphical user interface (GUI) to enable the recipient to make donations. According to one embodiment, the web site interface 82 queries the card holder for the holder's personal identification code 22, which is then verified in order to permit the card holder to use the services provided through web site 80. Once the card holder is verified, the interface 82 may present various options for the card holder to select in order to make donations. Possible options include, without limitation, selecting among possible donation recipients, indicating amounts to be donated, specifying purposes for the donations, and specifying the time(s) that donations will be made.

Although this example discusses making donations online, other scenarios are possible. For example, a kiosk (not expressly shown) having a card interface (such as interface device 40) may be provided to enable a card holder to make donations. Card interface 40 may include any device or devices for reading information from and/or writing information to cards 14. For example, card interface 40 may be a credit card authorization interface, a smart card reader, a debit card reader, or a stored value card reader, for example. Card interface device 40 may be operable to read data from and/or write data to one or more types of memory devices 30 provided on cards 14. Card interface device 40 may interface with such memory devices 30 provided on cards 14 via physical contact or otherwise, such as via radio or electromagnetic waves, for example.

The card holder may swipe the card, or insert the card in the device (or otherwise have the card read by the device) in order to activate an application which allows the card holder to select from among the various donations options. It should be understood that such a kiosk may also be used in order to allow customers to purchase charity gift cards. According to one embodiment, the kiosk is an automatic teller machine (ATM).

According to another option, a card holder may call a specified number and speak to an operator. The operator may be at the issuer location and using an operator terminal 58. Alternatively the operator may be located remotely from the issuer. The operator may verbally request the user's personal identification code 22, verify the code through the terminal 58, and query the user regarding the various donation options. According to another option, the telephone transaction may be conducted by a menu and/or voice recognition system. Any suitable method or system may be employed for allowing a card holder to use the card to make donations. Preferably, the system or method involves using information provided on, or incorporated into, the card, which information is associated with the parameters and options for making donations.

Regardless of the configuration employed, a component of the system may read the current monetary value 20, personal identification code 22, card identification code 24 and/or expiration data 26 from memory device(s) 30 on card 14. The cardholder may then provide (or attempt to provide) a code matching the personal identification code 22, such as by speaking the code to an operator or other personnel associated with the merchant 12 or by manually (e.g. by typing or keying) or otherwise entering the code into an interface, such as a card interface device 40, for example. For the online configuration, it may be necessary for the card holder to first enter an identifier so that the system may identify a record associated with the card. The number may be, for example, the card identification code, or simply an account number printed on the card. At this point, the card holder may be prompted to provide the personal identification code. The system may then match the number entered by the card holder with a code stored in the record associated with the account. Once the personal identification code is matched, or verified, then the card holder may select the various donation parameter to execute the desired charitable donation.

Issuer 12 may include any entity suitable for selling or otherwise providing cards 14 to customers and/or accepting donations from cards 14, or made in accordance with the information incorporated into card 14. An issuer 12 may include a single entity (such as, for example, an individual bank) or a number of entities (such as, for example, a group of charities). Issuer 12 may include one or more outlets at one or more physical locations and may, in addition or as an alternative, include one or more call centers where phone donations are received from customers using cards 14, one or more websites or other virtual locations where electronic donations are received from customers using cards 14.

Issuer 12 may include a card management system 50 that provides various functionality with respect to cards 14, such as, for example, generating cards 14, selling cards 14 to customers, setting-up cards 14 (such as storing a monetary value and or PIN in the memory provided by cards 14, for example), activating cards 14 for use, enabling transactions (e.g., charitable donations) using cards 14, providing security for such transactions, managing the monetary value stored on cards 14, and deactivating cards 14 (such as when a card 14 has expired, for example).

Card management system 16 may include a card interface device 40, a plurality of function modules 52, a data management system 56, and one or more operator terminals 58. The components of card management system 16 may be located at one or more sites and may be coupled to each other using one or more links, each of which may include, for example, some or all of a computer bus, local area networks (LANs), metropolitan area networks (MANs), wide area networks (WANs), portions of the Internet, a public switched telephone network (PSTN), any other appropriate wireline, optical, wireless, or other suitable communication link, or any combination of the preceding.

An operator terminal 58 may provide an operator with access to data management system 56 to obtain information from, exchange information with, manage, configure, or otherwise interact with data management system 56. Operator terminal 58 may include a computer system. As used in this document, the term “computer” refers to any suitable device operable to accept input, process the input according to predefined rules, and produce output, for example, a personal computer, workstation, network computer, wireless data port, wireless telephone, personal digital assistant, one or more processors within these or other devices, or any other suitable processing device. Operator terminal 58 may include or be partially or completely integrated with card interface device 40 and/or data management system 56. For example, an operator terminal 58 may be a combined cash register and card interface device 40 that includes data management system 56.

Data management system 56 may manage data associated with cards 14, which may in particular embodiments include creating, modifying, and deleting data files associated with cards 14. Additionally, data management system 56 may call one or more function modules 52 to provide particular functionality according to particular needs, as described more fully below. Data management system 56 may include a data processing unit 60, a memory unit 62, a network interface 64, and any other suitable components for managing data associated with cards 14. The components of data management system 56 may be supported by one or more computer systems at one or more sites. One or more components of data management system 56 may be separate from other components of data management system 56, and one or more suitable components of data management system 56 may, where appropriate, be incorporated into one or more other suitable components of data management system 56.

Data processing unit 60 may process data associated with cards 14, which may include executing software or coded instructions that may in particular embodiments be associated with the one or more function modules 52. Memory unit 62 may be coupled to data processing unit 60 and may include one or more suitable memory devices, such as one or more random access memories (RAMs), read-only memories (ROMs), dynamic random access memories (DRAMs), fast cycle RAMs (FCRAMs), static RAM (SRAMs), field-programmable gate arrays (FPGAs), erasable programmable read-only memories (EPROMs), electrically erasable programmable read-only memories (EEPROMs), microcontrollers, or microprocessors.

A function module 52 may provide particular functionality associated with handling cards 14, such as, for example, generating cards 14, selling cards 14 to customers, setting up cards 14, activating cards 14 for use, enabling donations using cards 14, providing security, managing the monetary values 20 stored on cards 14, and/or deactivating cards 14, for example. A function module 52 may be called by data management system 56 to the particular functionality associated with the function module 52.

According to the embodiment shown in FIG. 1, function modules 52 may include a card vending module 70, a card setup module 72, a card activation module 74, and a transaction module 76. Like data management system 56, function modules 52 may be physically distributed such that each function module 52 or multiple instances of each function module 52 may be located in a different physical location geographically remote from each other, from data management system 56, or both. In addition, each function module 52 may be partially or completely integrated with other function modules 52 and/or with other components of card management system 16. For example, particular function modules 52 may include one or more operator terminals 58 such that at least a portion of the functionality of such function modules 52 is provided by human operators. Thus it should be understood that the functionality provided by each function module 52 may be completely automated, partially automated, or completely human-controlled.

Card vending module 70 may provide functionality associated with selling cards 14 to customers. For example, card vending module 70 may receive a payment for a card 14 from a customer and provide the card 14 to the customer. In some embodiments, card vending module 70 may also generate cards 14, which may include storing particular data in the memory device(s) 30 provided on each card 14. Card vending module 70 may provide cards 14 having various data pre-loaded on the cards 14, such as initial monetary value 20, a card identification code 24 and/or an expiration date 26 for the card 14.

Card setup module 72 may provide functionality associated with setting up cards 14. For example, card setup module 72 may be operable to write, or store, various data in memory device(s) on a card 14, including one or more of an initial monetary value 20, a personal identification code 22, a card identification code 24 and/or an expiration date 26 for the card 14. Some or all of such data may be stored on a card 14 before the card is sold to a customer, or during the purchase of the card 14. In some embodiments, a cashier or other personnel associated with a merchant 12 may interface with card setup module 72 in order to facilitate setting up a card 14 for a customer. In other embodiments, card setup module 72 may be completely or substantially automated, such that a customer may enter desired parameters for the card 14 (e.g., initial monetary value 20 and/or customer identification code 22) into an interface associated with card setup module 72, and card setup module 72 may automatically set up the card 14 for the customer according to such parameters.

For example, regarding the initial monetary value 20, card setup module 72 and card vending module 70 may cooperate such that card vending module 70 provides an unloaded card 14 (in other words, a card not yet having a stored monetary value 20) for sale, a customer purchases the card 14 by making a payment to merchant 12, and card setup module 72 is used to store a monetary value 20 in a memory device 30 provided on card 14 based on the payment received from the customer. The monetary value 20 that card setup module 72 stores on card 14 may be equal to the amount of the customer's payment. Alternatively, card setup module 72 may determine a different amount of monetary value 20 to load onto the card 14. For example, card setup module 72 may take a fee from the customer's payment and the monetary value 20 stored on the card 14 may thus be less than the payment by some predetermined amount. As another example, card setup module 72 may give a bonus as an incentive for purchasing the card 14 and the monetary value 20 stored on the card 14 may thus be greater than the payment by some predetermined amount.

As another example, regarding personal identification code 22, card setup module 72 and card vending module 70 may cooperate such that card vending module 70 provides a card 14 for sale, a customer purchases the card 14 by making a payment to issuer 12 and communicating a desired personal identification code 22 to card setup module 72 (e.g., by communicating the desired personal identification code 22 to an operator, who enters the code into an interface, or by manually or otherwise entering the code into a customer interface, such as a card interface device 40, for example). Card setup module 72 may then write, or store, the customer's desired personal identification code 22 into a memory device 30 on the card 14. In some embodiments, a first customer may purchase a card from card vending module 70 at a issuer 12, transfer the card to a recipient (e.g., as a gift or otherwise), and the recipient may then visit (e.g., physically, by telephone, or online) the issuer 12 to have a personal identification code 22 selected by the recipient stored on the card 14 by card setup module 72 at the merchant 12.

Card activation module 74 may be generally operable to activate a card 14 for use. Card activation module 74 may be completely or partially integrated with card vending module 70 and/or card setup module 72. The card owner or holder, or a cashier or other personnel associated with a merchant 12, may interface with card activation module 74 in order to activate a purchased card. Card activation module 74 may read the card identification code 24 stored on the card 14 being activated and communicate the card identification code 24 to storage, such as memory unit 62, in order to create a record that the card 14 has been activated.

Transaction module 76 may be generally operable to manage transactions (or attempted transactions) made using a card 14. For example, transaction module 76 may be operable to receive a card 14, or information from the card, from a recipient intending to make a donation. The transaction module 76 may compare received information to stored information to permit the transaction. For example, transaction module 76 may compare the personal identification code 24 from the appropriate memory device 30 (or verbally provided or entered on a keyboard) with a stored record associated with the card and accessed using additional information from the card or the recipient.

In at least one alternative embodiment, the charity gift card 14 is linked with an account. The account may be, for example, a financial account held by the giver of the card. For instance, the card may be linked to the giver's credit card account. In such a scenario, the giver's account may be debited for the amount of the donations made by the recipient of the card. This may be accomplished when the card is purchased by the giver. Alternatively, this may be accomplished at a later time, such as when the recipient actually executes a donation. The account to which the card is linked may be any suitable account including any suitable financial account. For example, the account may be a credit card account, debit account, savings or checking account, investment account, or other financial account. The account holder may be the purchaser of the card (the giver), or may be some other person or entity. In certain situations, the account holder may be required to approve a donation prior to the funds being charged to the account.

FIG. 2 illustrates an example method for providing, activating, and using a charity card to make donations in accordance with an embodiment of the invention. At step 100, a customer may purchase a charity gift card 14 from an issuer 12. The card 14 may have an initial monetary value 20, a card identification code 24 and/or an expiration date 26 stored in one or more memory devices 30 provided on the card 14. For example, the customer may pay a cashier (or may make an electronic payment, for example) at the issuer 12 an amount equal to, more than, or less than the monetary value 20 stored on the card. Alternatively, the first customer may select a desired monetary value 20 for the card, which may then be stored on the card.

At step 102, the customer may give the card 14 to a recipient, for example, as a gift. At step 104, the recipient may visit the issuer 12 to activate the card 14 and/or select a desired personal identification code 22 for the card 14. The recipient and personnel associated with issuer 12 may interface with card activation module 74 and card setup module 72 to activate the card 14 and store the recipient's desired personal identification code 22 on the card 14. Alternatively, the setup may be accomplished online via web interface 82. Any other suitable method may be employed for setting up card 14.

At step 106, the recipient may make a charitable donation using the card 14. The recipient may present the card to a card interface device 40, which may read various information stored in memory device(s) 30 on the card, such as the monetary value 20, personal identification code 22, card identification code 24 and/or expiration date 26 stored on the card 14. Alternatively, the recipient may conduct the transfer of such information through the use of web interface 82.

Issuer 12 may sell charity cards 14 which are pre-loaded with various monetary values, such as $20, $50, and $100. Alternatively, issuer 12 may sell an unloaded charity gift card 14, which may be loaded with any amount desired by the customer purchasing the card 14. In one embodiment, issuer 12 provides the cards 14 through a web site. Customers select the type of card 14 desired and the amount desired to be loaded on the card 14. Then, the customer makes an online payment and the card 14 is mailed to the customer or a recipient designated by the customer. The “type of card” can refer to any of a variety of donation configurations. For example, the card may be set up such that the customer selects a single charity for which the receiver of the card can make donations. The selection may be from a predetermined list provided by the issuer 12, of the customer may specify a particular charity or charities, which the issuer may approve or reject. Optionally, the customer may choose a plurality of charities. In this case, the customer may determine that the receiver will be able to make specified donations to each of the plurality of charities. For example, the customer might select Charities A and C from the list of the charities offered by issuer 12 and may further specify that certain amounts must be donated by the recipient to each of Charities A and C. Or, the customer may specify that other parameters associated with the donations, such as the recipient being required to donate an amount within a certain range to Charity A and another amount within a certain range (or the remainder of the total initial amount) to Charity C. As another example alternative, the customer may also specify that the recipient will be able to make a second selection, from among the charities identified in the first selection by the customer, according to which contributions will be made. For instance, the customer might make a first selection of Charities A, B, C and D from the list of the charities offered by issuer 12. The recipient however, might choose to make a donation only to Charity A, or to Charities A and C.

The customer may also specify an amount for which the charitable donation will be made. Several options exist with respect to the amount of donations. According to one option, the customer may specify a fixed amount. This may be earmarked for a specific charity or for a plurality of charities. If it is earmarked for a plurality of charities, the purchaser may dictate how the amount will be divided among the plurality of charities, or the customer may leave this decision to the recipient. As another alternative, the customer may specify a certain cap amount. For example, the customer may leave the amount of charitable donations to be decided by the recipient. Thus, the recipient would choose (up to a certain maximum amount) how much he or she wishes to donate. According to another option, the customer may specify a certain amount (or a cap) for each of a plurality of charities.

Other options exist for specifying the amounts and the charity entities. For example, the customer may specify amounts and/or entities according to any of a variety of scenarios and then associated those parameters with a time parameter. For instance, a customer might specify that the recipient can donate up to a certain total amount and split that amount among three of ten different charities, and may further specify that the recipient must make the donations within one year. Another time parameter alternative is that the customer specifies a certain amount that may be donated each of a plurality of periods. For example, the recipient might be enabled to make a $50 donation every month for a certain time (e.g., one year) to one or more charities selected by the recipient. The periodic amount might be fixed with the recipient being allowed to choose the charity. However, the charity might be fixed with the recipient selecting the periodic amount. This amount may be capped by the customer.

In at least one embodiment, the customer may predetermine whether the customer or the recipient will receive credit for making the charitable contribution. For example, the recipient might be able to make the contribution, while the customer retains the right to claim the contribution as a tax deduction. In other cases, the customer might designate that the recipient will be able to make the contribution and also claim the deduction. In still other cases, the method may be set to a default in which it is predetermined that either the customer or the recipient will be entitled to the deduction. In still other cases, the deduction may be shared. In at least one embodiment, the system automatically generates correspondence to either the customer and/or the recipient, as applicable, with information regarding the charitable donation. Preferably, the correspondence includes information that will support a tax deduction claim based on the contribution (or the purchase of the gift card). In another embodiment, tax deduction information is automatically included on one or more periodic statements sent to either the customer or the recipient (or both).

In still another embodiment, a customer may use points or miles (or some other account award) to purchase the gift card. Optionally, the recipient may enhance the value of the gift card by using cash, credit, points, miles, etc.

Modifications, additions, or omissions may be made to the method without departing from the scope of the invention. Additionally, steps may be performed in any suitable order without departing from the scope of the invention.

Although an embodiment of the invention and its advantages are described in detail, a person skilled in the art could make various alterations, additions, and omissions without departing from the spirit and scope of the present invention as defined by the appended claims.

1. A system for enabling donations, comprising
at least one processor; and
at least one data storage device electronically coupled to the at least one processor,
the at least one processor operable to receive, from a first entity, a purchase request comprising a selection of one or more donation parameters, the selection comprising at least one potential donation recipient and at least a monetary amount,
the at least one data storage device operable to store information associated with the purchase request;
the at least one processor being further operable to receive a donation request comprising at least one donation recipient and at least one monetary amount.

2. The system of claim 1, wherein the at least one potential donation recipient comprises a plurality of potential donation recipients.

3. The system of claim 1, wherein the at least one potential donation recipient is a potential donation recipient included in a plurality of potential donation recipients presented to the first entity.

4. The system of claim 1, wherein the donation request is received from a second entity, which is different than the first entity.

5. The system of claim 1, further comprising an account module operable to link at least a portion of the purchase request information to a separate account.

6. The system of claim 1, further comprising an account module operable to link at least a portion of the donation request information to a separate account.

7. The system of claim 1, wherein the donation request is associated with a donation and wherein the donation is linked to a separate financial account.

8. The system of claim 7, wherein an amount of the donation is deducted from the separate financial account.

9. The system of claim 7, wherein the separate financial account is an account held by the first entity.

10. The system of claim, 9, wherein the separate financial account is a credit card account.

11. The system of claim 9, wherein the separate financial account is a savings account.

12. The system of claim 9, wherein the separate financial account is a checking account.

13. The system of claim 1, wherein at least a portion of the purchase request information is incorporated into a monetary card.

14. The system of claim 13, wherein the incorporated information is embedded in a magnetic stripe on the card.

15. The system of claim 1, further comprising a monetary card having at least a portion of the purchase request information incorporated therein, the monetary card being used to make the donation request.

16. The system of claim 1, wherein the donation request is received telephonically.

17. The system of claim 1, wherein the donation request is received by using a card reader to read information from a monetary card.

18. The system of claim 1, wherein the donation request is received through a web-based communications network.

19. The system of claim 1, wherein the donation request is received over a computer network.

20. A method for providing a donation gift card, comprising:
providing a card to a first entity, the card incorporating at least a first value corresponding to a first donation parameter;
receiving information associated with a donation after the donation has been made using the card, the donation information corresponding to the first donation parameter.

21. The method of claim 20, wherein the first donation parameter is one of a plurality of donation parameters.

22. The method of claim 20, wherein the card incorporates a plurality of values, each corresponding to one of a plurality of donation parameters.

22. The method of claim 20, wherein the first donation parameter is a monetary parameter.

23. The method of claim 20, wherein the first parameter comprises at least one potential donation recipient.

24. The method of claim 20, wherein the at least a first value comprises a first value and a second value, the first value representing at least one potential donation recipient and the second value representing at least one monetary amount.

25. The method of claim 20, wherein the receiving step comprises receiving the donation information from a second entity.

26. The method of claim 20, wherein the first donation parameter is a plurality of potential donation recipients selected by the first entity, the selection being made from a group of potential donation recipients presented to the first entity.

27. The method of claim 26, wherein the donation information is received from a second entity and the donation information comprises at least one donation recipient selected from the plurality of potential donation recipients of the first donation parameter.

28. The method of claim 20, wherein the donation information comprises at least one monetary value and at least one donation recipient.

29. The method of claim 20, wherein the first donation parameter is a time parameter.

30. The method of claim 20, further comprising the step of executing a donation based at least in part on the donation information.

31. The method of claim 20, further comprising the step of linking the at least a first value to a separate financial account.

32. The method of claim 31, wherein the separate financial account is an account held by the first entity.

33. The method of claim 31, further comprising the step of executing a donation based at least in part on the donation information, and the step of debiting the separate financial account.

34. The method of claim 33, wherein the step of debiting the separate financial account occurs after the step of receiving the donation information.

35. The method of claim 33, wherein the step of debiting the separate financial account occurs in connection with the step of providing the card to the first entity.

36. The method of claim 20, further comprising determining who, between the first entity and a second entity, will be entitled to claim a tax deduction based on the donation.

37. The method of claim 20, wherein the first entity establishes the value based on a financial contribution.

38. The method of claim 20, wherein the first entity reimburses account awards to establish the value.
